(19) United States
(12) Patent Application Publication
(10) Pub. No.: US 2013/0081832 A1
(43) Pub. Date: Apr. 4, 2013

(54) CRACK AND CREVICE WEEDER TOOL

(71) Applicant: SAMUEL SPECTOR, Edison, NJ (US)

(72) Inventor: SAMUEL SPECTOR, Edison, NJ (US)

(21) Appl. No.: 13/485,988

(22) Filed: Jun. 1, 2012

Related U.S. Application Data
(60) Provisional application No. 61/573,769, filed on Sep. 13, 2011.

(51) Int. Cl. A01B 1/16

(52) U.S. Cl. CPC A01B 1/16
USPC 172/13

(57) ABSTRACT

A tool for removing undesired growth between adjacent surfaces includes a pair of flanges of generally equal width and length symmetrically located about a central axis and having a front end and a back end. The flanges are shaped to form a generally curved V-shaped opening at their front end whose width decreases gradually in a curved manner to form a narrow region terminating at an end point along the central axis. The flanges Kaye inner facing surfaces which are disposed with respect to each other to define an interior angle which may vary over a wide range. A handle is attached via a bracket to the flanges for enabling the front end of the flanges to be urged under undesirable growth, and wedging the undesirable growth within the narrow region for enabling the removal of the undesirable growth with its roots.

### BACKGROUND OF THE INVENTION

This application claims priority based on provisional application bearing Ser. No. 61/573,769, filed Sep. 13, 2011 and titled CRACK AND CREVICE WEEDER TOOL, whose teachings are incorporated herein by reference.

This invention relates to tools and apparatus for removing weeds from cracks and crevices in sidewalks, driveways, patios and between cement slabs and similar structures.

Known weeding tools (devices) are constructed to remove weeds by cutting the portion of the weeds that extend above a surface. This does not remove the roots of the weeds below the surface and the weeds just grow back again. Other known tools are constructed so that the weeding tool and the cutting edge are pulled towards the user. The pulling motion is uncomfortable, requires the exertion of much force and, if there is a slip, may cause the tool to hit the user. Moreover, these tools do not allow the removal of weeds growing in a crevice along the edge (corner) of a vertical and horizontal surface (e.g., the side of a house and a driveway).

These disadvantages are overcome in tools embodying the invention.

### SUMMARY OF THE INVENTION

A tool for removing undesired growth between adjacent surfaces (e.g., two adjacent horizontal slabs of cement) includes a pair of flange members of generally equal width and length symmetrically located about a central axis and having a front end and a back end. The flange members are shaped to form a generally curved V-shaped opening, centrally located along their front end, whose width decreases gradually in a curved manner to form a narrow region terminating at an end point along the central axis. The flange members have inner facing surfaces which are disposed with respect to each other to define a predetermined interior angle. A handle is attached via a bracket to the flange members for enabling the front end of the flange members to be urged forward under undesirable growth and wedging the undesirable growth within the narrow region for enabling the removal of the undesirable growth with its roots.

### BRIEF DESCRIPTION OF THE DRAWINGS

In the accompanying drawings which are not drawn to scale, like reference characters denote like components, and

FIG. 1 is a perspective view of a tool embodying the invention;

FIG. 2 is a top view of the tool embodying the invention;

FIG. 3 is a cross sectional view of a weed capture between the flanges of the tool; and

FIG. 4 is a side view of the tool raising a weed with its roots.

### DETAILED DESCRIPTION OF THE FIGURES

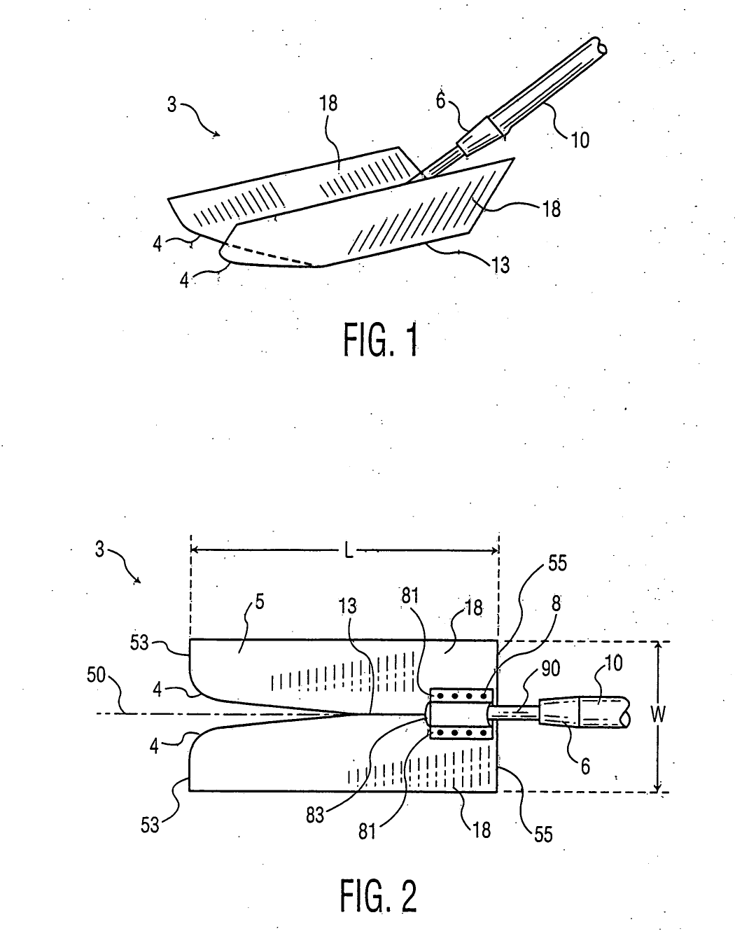

Referring to FIGS. 1 and 2 there is shown a tool 3 which may be formed by shaping a metallic plate 5 of width “W” and of length “L”. The width W and the length L may each range from a few inches to more than 12 inches.

The plate 5 may be folded, along its length, about a center line 50 of the plate 5 to from two flanges 18 of generally equal width and length. The flanges extend between a front end 53 and a back end 55 of the plate. The inner surfaces of flanges 18, at, and near, their front ends, along the center line 50, are cut away in a generally symmetrical fashion to form a curved V-shaped opening which decreases along a curve to form a slit terminating at an end point 13 along the center axis. The end point 13 may also be referred to as the apex. The distance of the end point 13 from the front end may range between one quarter and three quarters of the length L measured from the front end.

The cutaway at the front end of the flanges forms a V-shaped opening having rounded edges 4. Starting from the front end 53, the distance between the edges decreases gradually and smoothly terminating in a narrow slit which ends at apex 13. The shape of the opening is designed to enable weeds to wedged within the narrow sleet region near the apex 13 between the flanges 18.

Bracketing apparatus 8 for securing a handle 10 to the flanges is mounted generally symmetrically about the center line. In FIG. 2 the bracket 8 is shown to have a semi cylindrical portion 83 and two side brackets 81 which are firmly attached via any suitable means to their respective portions of the flanges. The handle 10 may have one end, a stub 90, inserted into and/or between the semi-cylindrical portion 83 and the flanges and this end 90 may be firmly attached to the flanges and/or the semi-cylindrical portion 83. The connection of stub 90 to handle 10 may include a ferrule 6. It should be appreciated that other means of securing a handle to the flanges may be used. The handle may extend at an acute angle with respect to the central axis of the flanges.

An advantage of the bracket 82 is that it can maintain the angle between the flanges fixed and at the same time add structural strength to the rear portion of the flanges. By maintaining an angle of, for example, about 90 degrees between the flanges it is possible to remove weeds in a crevice (corner) between a vertical surface and a horizontal surface.

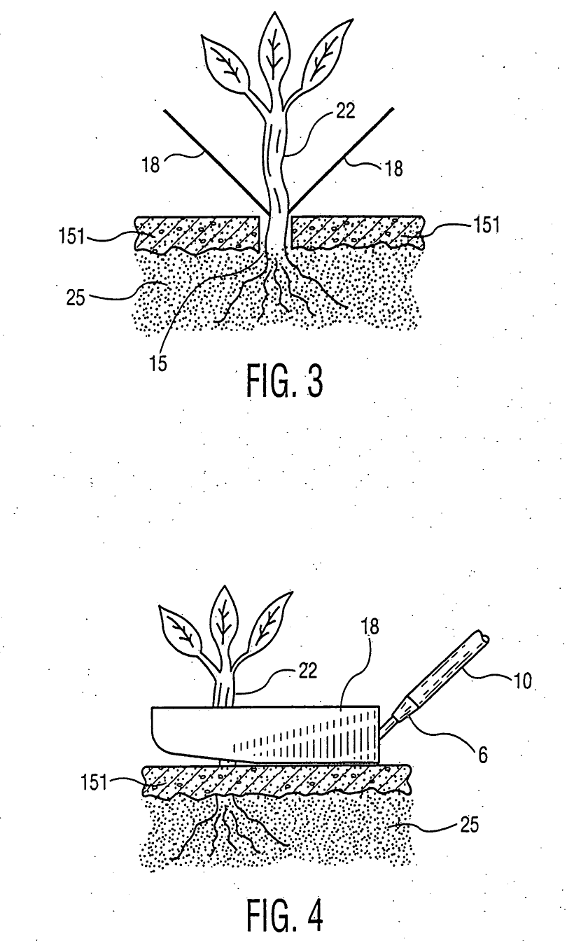

FIGS. 3 and 4 show how the tool 3 could be used to remove a weed growing, for example, in a crevice 15 between two slabs 151 of cement. The tool 3 would be pushed forward (with the weight of the user aiding) underneath the leafy portion of-the weed 22 with the opening between the flanges being urged underneath the weed 22. Pushing the tool in this manner causes the weed to be jammed (wedged) in the tool opening between the two flanges. When the weed is jammed (wedged) within the slit region of the tool, the weed and its roots can be removed by the upward movement of the tool 3. The upward movement can be achieved by lifting action or by cantilever motion.

Wedging the weed within the narrow opening region between the flanges is a unique feature of the tool. It enables the weed to be removed, roots and all, without cutting the weed at it base above ground.

The tool may be formed from a single piece of metal or from two or more pieces which may be combined to form a tool shaped as shown in FIGS. 1 and 2.

What is claimed is:

1. A tool for removing undesired growth comprising:
a metallic plate of width “W” and of length “L” extending between a front end and a back end of the plate, with a center axis extending along the length of the metallic plate; the metallic plate being cut generally symmetrically, about its front end, along the center axis, to form a curved V-shaped opening which decreases along a curve to form a slit terminating at an end point along the center axis, the distance of the end point from the front end ranging between one quarter and three quarters of the length L measured from the front end;
said metallic plate being bent about the center axis to form a pair of flange members, of generally equal width and length, having inner surfaces which define a predetermined interior angle relative to each other; and
means for attaching a handle to the flange members to enable the handle to be mounted between the pair of flange members, generally along the center axis and the handle extending upwardly therefrom for enabling as user to forwardly urge the curved V-shaped opening at the front end of the flange members under the undesirable growth and enabling the removal of undesirable growth.

2. A tool as claimed in claim 1 wherein said means for attaching a handle includes a bracket securely mounted on the flange members for the insertion therein of said handle and said bracket also adding sturdiness to the flange members and maintaining the predetermined angle between the inner surfaces.

3. A tool, as claimed in claim 2, wherein said bracket is mounted along the inner surfaces of the flange members generally symmetrically about said center axis and is located in an area between said end point and said back end.

4. A tool as claimed in claim 1 wherein the predetermined angle is set to have a value ranging from less than 90 degrees to less than 180 degrees.

5. A tool for clearing spaces and undesired growth between adjacent-slabs of paving material, said tool comprising:
a pair of flange members of generally equal width (D) extending from a central axis, the flange members being of length (L) extending between a front end and a back end;
the pair of flange members have inner surfaces which are disposed with respect to each other to define a predetermined interior angle;
the pair of flange members being cut away at their front end, along the center axis, to form a generally curved V-shaped opening and the opening decreasing gradually in a curved manner to form a slit terminating at an end point along the center axis, the end point being at a distance ranging between one quarter and three quarters of the length L from the front end, and the pair of flange members having a common surface extending from the end point to the back end; and
means for mounting a handle between the pair of flanges, the handle being mounted generally along the center axis and extending upwardly therefrom for forwardly urging the front end of the flange members under the undesirable growth and enabling the removal of undesirable growth.

6. A tool as claimed in claim 5 wherein the flange members are made of metal.

7. A tool as claimed in claim 6 wherein said means for mounting a handle includes a bracket securely mounted on the flange members for the insertion therein of said handle and said bracket also adding sturdiness to the flange members and maintaining the angle between the inner surfaces.

8. A tool as claimed in claim 5 wherein the interior angle can range in value from less than 90 degrees to less than 180 degrees

9. A tool for removing undesired growth comprising:
a metallic plate of width “W” and length “L” extending between the front end and back end of the plate, with a center axis extending along the length of the plate; said metallic plate being bent about the center axis to form a pair of flange members, of generally equal width, whose inner surfaces define a predetermined interior angle; the flange members having a front end and a back end;
the pair of flange members being cut away at their front end, along the center axis, to form a generally curved V-shaped opening and the opening decreasing gradually into slit and terminating at an end along the center axis, the end point being a distance ranging between ¼ and ¾ of the length L from the front end, and the pair of flange members being joined from the end point to the back end; and
a handle mounted between the pair of flanges, generally along the center axis and extending upwardly therefrom for urging the front end of the flange members under the undesirable growth and enabling the removal of undesirable growth.

10. A tool for removing undesired growths claimed in claim 9 wherein the interior angle can range in value from less than 90 degrees to less than 180 degrees.
